SEQUENCE LISTING (4 sequences)

SEQ ID NO: 1 - protein, 429 aa, Homo sapiens
MCPGALWVALPLLSLLAGSLQGKPLQSWGRGSAGGNAHSPLGVPGGGLPEHTFNLKMFLENVKVDFLRSLNLSGVPSQDKTRVEPPQYMIDLYNRYTSDKSTTPASNIVRSFSMEDAISITATEDFPFQKHILLFNISIPRHEQITRAELRLYVSCQNHVDPSHDLKGSVVIYDVLDGTDAWDSATETKTFLVSQDIQDEGWETLEVSSAVKRWVRSDSTKSKNKLEVTVESHRKGCDTLDISVPPGSRNLPFFVVFSNDHSSGTKETRLELREMISHEQESVLKKLSKDGSTEAGESSHEEDTDGHVAAGSTLARRKRSAGAGSHCQKTSLRVNFEDIGWDSWIIAPKEYEAYECKGGCFFPLADDVTPTKHAIVQTLVHLKFPTKVGKACCVPTKLSPISVLYKDDMGVPTLKYHYEGMSVAECGCR

SEQ ID NO: 2 - protein, 429 aa, synthetic construct
MCPGALWVALPLLSLLAGSLQGKPLQSWGRGSAGGNAHSPLGVPGGGLPEHTFNLKMFLENVKVDFLRSLNLSGVPSQDKTRVEPPQYMIDLYNRYTSDKSTTPASNIVRSFSMEDAISITATEDFPFQKHILLFNISIPRHEQITRAELRLYVSCQNHVDPSHDLKGSVVIYDVLDGTDAWDSATETKTFLVSQDIQDEGWETLEVSSAVKRWVRSDSTKSKNKLEVTVESHRKGCDTLDISVPPGSRNLPFFVVFSNDHSSGTKETRLELREMISHEQESVLKKLSKDGSTEAGESSHEEDTDGHVAAGSTLARRKRSAGAGSHCQKTSLRVNFEDIGWDSWIIAPKEYEAYECKGGCFFPLADDVTPTKHAIVQTLVHLKFPTKVGKACCVPTKLSPISVLYKDDAGVPTLKYHYEGMSVAECGCR

SEQ ID NO: 3 - protein, 110 aa, synthetic construct
SAGAGSHCQKTSLRVNFEDIGWDSWIIAPKEYEAYECKGGCFFPLADDVTPTKHAIVQTLVHLKFPTKVGKACCVPTKLSPISVLYKDDMGVPTLKYHYEGMSVAECGCR

SEQ ID NO: 4 - protein, 110 aa, synthetic construct
SAGAGSHCQKTSLRVNFEDIGWDSWIIAPKEYEAYECKGGCFFPLADDVTPTKHAIVQTLVHLKFPTKVGKACCVPTKLSPISVLYKDDAGVPTLKYHYEGMSVAECGCR

(19) United States
(12) Patent Application Publication
(10) Pub. No.: US 2026/0363233 A1
(43) Pub. Date: Nov. 19, 2026

(54) COMPOSITIONS AND METHODS FOR IMPROVING ORGAN VIABILITY

(71) Applicant: Northwestern University, Evanston, IL (US)

(72) Inventors: Logan Donald Langerude, Evanston, IL (US); Zhenxiao Tu, Evanston, IL (US); Carl Atkinson, Evanston, IL (US); Blake Cole Gill, Evanston, IL (US)

(21) Appl. No.: 19/657,351

(22) Filed: Apr. 24, 2026

Related U.S. Application Data
(60) Provisional application No. 63/794,570, filed on Apr. 25, 2025.

(51) Int. Cl. A01N 1/126; A01N 1/125

(52) U.S. Cl. CPC A01N 1/126; A01N 1/125

(57) ABSTRACT

Provided herein are compositions comprising an activator of BMP9 signaling and an osmotic agent and methods of use thereof, including for improving organ viability. The activator of BMP9 signaling may be a BMP9 polypeptide, an inhibitory SMAD inhibitor, a SMURF inhibitor, or a combination thereof.

### PRIORITY STATEMENT

This application claims priority to U.S. Provisional Patent Application No. 63/794,570, filed Apr. 25, 2025, the entire contents of which are incorporated herein by reference for all purposes.

### SEQUENCE LISTING

The text of the computer readable sequence listing filed herewith, titled “NWEST-44926-202_SQL.xml”, created Apr. 24, 2026, having a file size of 5,576 bytes, is hereby incorporated by reference in its entirety.

### FIELD

Provided herein are organ preservation compositions comprising one or more activators of bone morphogenetic protein 9 (BMP9) signaling, and methods of improving organ viability involving administration of one or more activators of bone morphogenetic protein 9 (BMP9) signaling to the organ.

### BACKGROUND

There is a shortage of organs suitable for transplantation, with the demand for lung transplant vastly outstripping the available donor organ pool. Ischemia reperfusion injury is common in transplant, the most severe forms of which can lead to primary graft failure. However, methods for reducing ischemia reperfusion injury and improving outcomes prior to or after transplantation are lacking.

### SUMMARY

In some aspects, provided herein are organ preservation compositions comprising an osmotic agent and at least one BMP9 signaling activator. In some embodiments, the osmotic agent is an oncotic agent. In some embodiments, the oncotic agent comprises dextran, albumin, gelatin, hydroxyethyl starch, and/or polyethylene glycol. In some embodiments, the composition further comprises one or more sugars, electrolytes, antioxidants, free radical scavengers, amino acids, buffering agents, vasodilators, antibiotics, anti-inflammatory agents, and/or chelators. In some embodiments, the at least one BMP9 signaling activator comprises a BMP9 polypeptide; and/or a SMAD6 and/or SMAD7 inhibitor, and/or a SMURF inhibitor.

In some embodiments, the at least one BMP9 polypeptide comprises an amino acid sequence having at least 90% sequence identity to SEQ ID NO: 3 or SEQ ID NO: 4. In some embodiments, the at least one BMP9 polypeptide comprises SEQ ID NO: 3 or SEQ ID NO: 4. In some embodiments, at least one BMP9 polypeptide comprises an amino acid sequence having at least 80% identity to SEQ ID NO: 1 or SEQ ID NO: 2. In some embodiments, the at least one BMP9 polypeptide comprises an amino acid sequence having at least 90% identity with SEQ ID NO: 1 or SEQ ID NO: 2. In some embodiments, the at least one BMP9 polypeptide comprises an amino acid sequence having at least 95% identity with SEQ ID NO: 1 or SEQ ID NO: 2. In some embodiments, the at least one BMP9 polypeptide comprises SEQ ID NO: 1 or SEQ ID NO: 2. In some embodiments, SMURF inhibitor is A01. In some embodiments, the at least one BMP9 signaling activator comprises a BMP9 polypeptide and a SMURF inhibitor.

In some aspects, provided herein are methods of improving organ viability, comprising contacting the organ with the organ preservation composition herein. In some embodiments, provided herein are methods of improving organ viability comprising contacting the organ with at least one bone morphogenetic protein 9 (BMP9) signaling activator. In some embodiments, the at least one BMP9 signaling activator promotes BMP9-mediated phosphorylation of receptor-associated SMAD proteins (SMAD1/5/9); is an inhibitor of one or more inhibitory SMAD proteins (I-SMADs, namely SMAD6 or SMAD7); and/or is a Smad ubiquitin regulatory factor (SMURF) inhibitor. For example, in some embodiments the at least one BMP9 signaling activator comprises a BMP9 polypeptide; and/or a SMAD6/SMAD7 inhibitor, and/or a SMURF inhibitor (e.g. SMURF1 or SMURF2 inhibitor).

In some embodiments, the organ is a lung, liver, or kidney. In some embodiments, contacting the organ with the at least one agent reduces endothelial cell loss or damage, reduces pulmonary edema, reduces glucose uptake, reduces lactate production, and/or increases probability of survival of the organ during storage and/or after transplantation into the recipient.

### BRIEF DESCRIPTION OF THE DRAWINGS

FIG. 1A shows the sequence of wildtype BMP9 (SEQ ID NO: 1). FIG. 1B shows the sequence of the 408A mutant of BMP9 (SEQ ID NO: 2).

FIG. 2 is a schematic illustration of a lung-on-a-chip model used herein.

FIG. 3 shows levels of markers of endothelial injury evaluated following CS-IRI.

FIG. 4A and FIG. 4B show imaging of endothelial cells after standard perfusion and CS-IRI.

FIGS. 5A-5D show exogenous BMP9 given over CS promotes HuLEC-5a BMP9 signaling post-CS-IRI. FIG. 5A shows western blot of phosphorylated SMAD proteins 1/5/9 in healthy tissues, and tissues after 6 hours, 18 hours, or 24 hours or reperfusion. FIG. 5B shows quantification of the results from FIG. 5A, demonstrating that SMAD signaling declines after 6 hr of reperfusion. FIG. 5C shows a western blot of phosphorylated SMAD portions 1/5/9 when WT BMP9 was given to HuLEC-5a cells at the time of reperfusion or prior to CS. Results are quantified in FIG. 5D, which shows that BMP9 delivered prior to CS and BMP9 delivered at the time of reperfusion are effective at inducing P-smad1/5/9 signaling. One-way ANOVA with post-hoc Tukey Test were used to perform statistical analysis. N=3.

FIGS. 6A-6D show administration of BMP9 to lung-on-a-chip platform optimized to simulate ex vivo lung perfusion (EVLP) induces a BMP9 signaling. FIG. 6A shows a PCA-X model generated of EVLP and EVLP+BMP9 treated Emulate Alveolar Lung-on-a-chips in SIMCA. N=3. The PCA-X was constructed from a Nanostring nCounter human organ transplant gene expression dataset from the mRNA collected from the vascular endothelial compartment of the lung-chip. FIG. 6B. SIMCA was then used to generate a dendrogram using Ward's criteria for hierarchal clustering. FIG. 6C. The volcano plot generated from nSolver v4.0. FIG. 6D. BMP9 treatment increased the expression of vascular endothelial bmp4, bmp6, endoglin, and id1 following CS-EVLP-IRI. N=3.

FIGS. 7A-7E show exogenous recombinant BMP9 significantly improves DCD porcine lung survival on EVLP and reduces pulmonary vascular leakage. FIG. 7A shows the experimental schematic of the donation-after-circulatory-death (DCD) lung model. (B) Kaplan-Meier survival analysis of lungs during EVLP. Statistical comparison shown (log-rank test, p=0.0204). (C) Lung wet-to-dry weight ratio of lower lobes following EVLP. Data are presented as mean±SEM. (D) Representative hematoxylin and eosin (H&E)-stained sections of lung tissue following EVLP across experimental groups. Quantification of lung injury score (right bar graph) demonstrates a reduction with BMP9 treatment compared to ΔP>2 lungs (p values as indicated). (E) Representative immunofluorescence images of lung tissue stained with DAPI (blue) and ZO-2 (red), a tight junction protein, following EVLP. Scale bar as indicated.

FIGS. 8A-8C show BMP9 delivery post-CS-IRI increases expression of I-SMADs, and SMURF1 inhibition can prolong BMP9 signaling. FIG. 8A shows a volcano plot generated from Qiagen's Ingenuity Pathway Analysis. Leftmost genes (green) are upregulated by CS and rightmost genes (red) are upregulated by BMP9 following CS-IRI. FIG. 8B shows a western blot depicting that with concomitant treatment of BMP9 and A01, a small molecule SMURF1 inhibitor, microvascular endothelial intracellular P-SMAD1/5/9 expression was increased post-CS-IRI. FIG. 8C shows the area under the curve (AUC) plotted to examine the effect of SMURF1 inhibition on signaling. The AUC value for controls was 7.969 and the AUC value for A01 treatment was 11.66.

FIGS. 9A-9B show BMP9 supplementation during prolonged cold storage preserves lung viability and enables successful transplantation in a rodent transplant model. FIG. 9A shows the experimental schematic of the prolonged cold storage lung transplant model. FIG. 9B shows representative gross images of transplanted lungs at 5 days post-transplantation. Lungs preserved with BMP9 during extended cold storage demonstrate preserved graft viability and perfusion, with maintained tissue integrity compared to expected deterioration following prolonged ischemic storage.

### DETAILED DESCRIPTION

### 1. Definitions

Although any methods and materials similar or equivalent to those described herein can be used in the practice or testing of embodiments described herein, some preferred methods, compositions, and materials are described herein. However, before the present materials and methods are described, it is to be understood that this invention is not limited to the particular molecules, compositions, methodologies or protocols herein described, as these may vary in accordance with routine experimentation and optimization. It is also to be understood that the terminology used in the description is for the purpose of describing the particular versions or embodiments only and is not intended to limit the scope of the embodiments described herein.

Unless otherwise defined, all technical and scientific terms used herein have the same meaning as commonly understood by one of ordinary skill in the art to which this invention belongs. However, in case of conflict, the present specification, including definitions, will control. Accordingly, in the context of the embodiments described herein, the following definitions apply.

As used herein and in the appended claims, the singular forms “a”, “an” and “the” include plural reference unless the context clearly dictates otherwise.

As used herein, the modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to ±10% of the indicated number. For example, “about 10%” may indicate a range of 9% to 11%, and “about 1” may mean from 0.9-1.1. Other meanings of “about” may be apparent from the context, such as rounding off; for example, “about 1” may also mean from 0.5 to 1.4.

For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

As used herein, the terms “comprise”, “include”, and linguistic variations thereof denote the presence of recited feature(s), element(s), method step(s), etc. without the exclusion of the presence of additional feature(s), element(s), method step(s), etc. Conversely, the term “consisting of” and linguistic variations thereof, denotes the presence of recited feature(s), element(s), method step(s), etc. and excludes any unrecited feature(s), element(s), method step(s), etc., except for ordinarily-associated impurities. The phrase “consisting essentially of” denotes the recited feature(s), element(s), method step(s), etc. and any additional feature(s), element(s), method step(s), etc. that do not materially affect the basic nature of the composition, system, or method. Many embodiments herein are described using open “comprising” language. Such embodiments encompass multiple closed “consisting of” and/or “consisting essentially of” embodiments, which may alternatively be claimed or described using such language.

The term “subject” broadly refers to any living organism, and more specifically to an animal including human and non-human animals. In some embodiments, the subject is a mammal. Examples of mammals include, but are not limited to, any member of the Mammalian class: humans, non-human primates such as chimpanzees, and other apes and monkey species; farm animals such as cattle, horses, sheep, goats, swine; domestic animals such as rabbits, dogs, and cats; laboratory animals including rodents, such as rats, mice and guinea pigs, and the like. Examples of non-mammals include, but are not limited to, birds, fish, and the like. In one embodiment, the mammal is a human.

### 2. Organ Preservation Compositions and Methods of Improving Organ Viability

In some aspects, provided herein are organ preservation compositions. As used herein, an “organ preservation composition” or “organ preservation solution” are used interchangeably and refer to a formulation used to preserve organs ex-vivo and/or during transplantation into a subject. The organ preservation compositions herein may be used to preserve organs immediately after harvesting from a donor, during cold storage of the organ, during an ex-vivo perfusion procedure (e.g. during ex-vivo lung perfusion, ex-vivo kidney perfusion, ex-vivo heart perfusion, etc.), and/or during transplantation into a subject.

In some embodiments, the organ preservation composition comprises an osmotic agent and a BMP9 signaling activator. An “osmotic agent” as used herein refers to a substance that prevents cellular swelling (e.g. edema) during organ preservation and/or following transplantation. An “osmotic agent” may prevent swelling and manage water tissue balance by creating a high osmotic pressure in the organ preservation solution (e.g. a creating a hypertonic solution), thus preventing water from flowing into cells and/or drawing water out of cells, preventing edema. For example, an osmotic agent may be an impermeant (e.g. a non-permeable moiety) that generates osmotic force and thus prevents water influx that would otherwise occur, e.g. if cells lose their ability to maintain sodium/potassium gradients. The impermeant may be a small molecule (e.g. saccharide, anion) or a large molecule. In some embodiments, the osmotic agent is an oncotic agent. An “oncotic agent” is a type of osmotic agent and refers to a substance that exerts colloid osmotic pressure and thereby manages fluid balance within an organ. “Colloid osmotic pressure” is a specific type of osmotic pressure exerted by large particles or colloids.

The compositions herein are demonstrated to improve organ viability. In some aspects, provided herein are methods of improving organ viability. The results herein demonstrate that modulation of BMP9 signaling, including by administration of bone morphogenetic protein 9 (BMP9) and/or inhibition of SMURF, improves multiple outcomes of organ health, including in model organ systems (e.g. a lung-on-a-chip) and ex-vivo organs. As such, activators of BMP9 signaling, including BMP9 and variants thereof, provide viable clinical agents for use in treating organs prior to or during transplant to improve viability of the organ prior to transplant (e.g. during storage, during ex-vivo perfusion) and during/after transplant into the subject.

As used herein, the term “organ” includes whole organs (e.g. whole lung, whole heart, whole liver, etc.) and portions/tissues thereof (e.g. lung tissue, heart tissue, etc.). Organs include the brain, pharynx, larynx, diaphragm, heart, arteries, stomach, muscles, liver, gallbladder, kidneys, large intestine, small intestine, skin, lymph nodes, lungs, spleen, stomach, veins, pancreas, uterus, and bladder. Commonly transplanted organs that may be used in the methods herein include the lungs, kidney, liver, and heart. In some embodiments, the organ is a lung.

In some embodiments, the organ is intended for transplant into a recipient (e.g. is a candidate organ for transplant). The terms “recipient” and “subject” are used interchangeably herein and refer to an entity into which transplantation is desired, intended, attempted, or achieved. The organ intended for transplant may be derived from a “donor”. The donor may be any suitable species compatible for transplantation with a subject. In some embodiments, the donor and the recipient are both mammals. In some embodiments, the donor and the recipient are both mammals, and the recipient is a human. In some embodiments, the donor and the recipient are both humans.

The organ may also be referred to herein as a “graft”. Typically, the term “graft” indicates that the organ has been transplanted into the subject.

In some aspects, provided herein are methods of improving organ viability comprising contacting an organ an organ preservation composition herein. In some aspects, provided herein are methods of improving organ viability comprising contacting an organ with at least one BMP9 signaling activator. Organ “viability” refers to the capacity of an organ to survive outside of the body (e.g. after recovery of the organ from a donor) and/or the capacity of an organ to function properly once transplanted into a recipient. “Improving organ viability” refers to improving the viability of an organ outside of the body (e.g. improving the viability of a pre-transplant organ, e.g. an organ after isolation from a donor and prior to engraftment in a host) and/or improving the viability of an organ after engraftment into a host (e.g. post-transplant). As such, “improving organ viability” may refer to improving the health of the organ outside of the body, and/or improving the health, function, and/or lifespan of the organ after transplant into a recipient. Organ viability may be measured by any suitable metric and the metrics used may vary depending on what specific organ is assessed. For example, organ viability may be assessed by metrics such as oxygenation capacity, pulmonary resistance, vascular resistance, flow rate, airway pressures, lung compliances, edema (wet to dry ratio), endothelial cell loss or damage, glucose uptake, lactate production, and/or biochemical markers such as levels of proinflammatory cytokines, troponin, B-type natriuretic peptide, etc. For example, lung transplant viability may be assessed by lung oxygenation capacity, pulmonary resistance, airway pressures, lung compliances, lung edema, endothelial cell loss or damage, glucose uptake, lactate production, and/or measures of proinflammatory cytokines. Kidney transplant viability may be assessed by flow rate, pressure, biochemical markers such as mitochondrial flavin mononucleotide, Neutrophil gelatinase-associated lipocalin (NGAL), creatinine, etc. Heart transplant viability may be assessed by coronary flow rate, vascular resistance, metabolic lactate levels, and/or biochemical markers such as troponin, BNP, etc. In some embodiments, organ viability is assessed by one or more of the above metrics during ex-vivo perfusion. Improvement in any one or more of the above metrics may be indicative of improved organ viability. In some embodiments, improved organ viability indicates or is associated with increased organ lifespan after transplant.

The canonical BMP9 signaling pathway involves phosphorylation of receptor-associated SMAD proteins (R-SMAD), namely SMAD1/5/9 (SMAD9 was formerly referred to as SMAD8). Phosphorylated SMAD proteins then interact with common SMAD (co-SMAD, SMAD4) which acts as a chaperone to translocate the R-SMAD/Co-SMAD complex into the nucleus where transcriptional regulation of target genes can occur. Two inhibitory SMADs (I-SMADs, namely SMAD6 and SMAD7), negatively regulate BMP signaling. In addition, Smurf proteins, which are ubiquitin ligases, interact with and ubiquitinate phosphorylated R-SMAD proteins, targeting them for degradation. As such, SMURF proteins effectively dampen the BMP9 signaling pathway. A “BMP signaling activator” may promote BMP9-mediated phosphorylation of receptor-associated SMAD proteins (e.g. SMAD1/5/9), inhibit or antagonize one or more inhibitory SMAD proteins (I-SMADs, e.g. SMAD6, SMAD7), and/or inhibit or antagonize a Smad ubiquitin regulatory factor (SMURF).

In some embodiments, the at least one BMP9 signaling activator comprises a BMP9 polypeptide. A “BMP9 polypeptide” as used herein is not intended to be limited to a rigid definition of a “polypeptide” but rather encompasses amino acid sequences, polypeptides, peptides, and proteins. The BMP9 polypeptide may be natural or synthetic. For example, a “BMP9 polypeptide” may refer to a peptide or polypeptide comprising a portion of a BMP9 sequence (e.g. a portion of SEQ ID NO: 1, a portion of SEQ ID NO: 2), may refer to a full length BMP9 sequence (e.g. SEQ ID NO: 1, SEQ ID NO: 2), or may refer to administration of a BMP9 protein (e.g. a wildtype BMP9 protein or a recombinant BMP9 protein). In some embodiments, a “BMP9 polypeptide” comprises a BMP9 protein, including a wildtype BMP9 protein or a recombinant or variant (e.g. mutant) BMP9 protein having one or more improved characteristics. For example, the mutant BMP9 protein comprising the amino acid sequence of SEQ ID NO: 2 has reduced osteogenic activity.

In some embodiments, the BMP9 polypeptide comprises SEQ ID NO: 1. SEQ ID NO: 1 is provided below: MCPGALWVALPLLSLLAGSLQGKPLQSWGRGSAGGNAHSPLGVPGGGLPEHTF NLKMFLENVKVDFLRSLNLSGVPSQDKTRVEPPQYMIDLYNRYTSDKSTTPASNIVRSFS MEDAISITATEDFPFQKHILLFNISIPRHEQITRAELRLYVSCQNHVDPSHDLKGSVVIYDV LDGTDAWDSATETKTFLVSQDIQDEGWETLEVSSAVKRWVRSDSTKSKNKLEVTVESH RKGCDTLDISVPPGSRNLPFFVVFSNDHSSGTKETRLELREMISHEQESVLKKLSKDGSTE AGESSHEEDTDGHVAAGSTLARRKRSAGAGSHCQKTSLRVNFEDIGWDSWIIAPKEYEA YECKGGCFFPLADDVTPTKHAIVQTLVHLKFPTKVGKACCVPTKLSPISVLYKDDMGVP TLKYHYEGMSVAECGCR (SEQ ID NO: 1).

In some embodiments, the BMP9 polypeptide comprises a sequence having at least 80% identity with SEQ ID NO: 1. In some embodiments, the BMP9 polypeptide comprises a sequence having at least 80%, at least 85%, at least 90%, at least 91%, at least 92%, at least 93%, at least 94%, at least 95%, at least 96%, at least 97%, at least 98%, at least 99%, or 100% identity with SEQ ID NO: 1.

In some embodiments, the BMP9 polypeptide comprises SEQ ID NO: 2. SEQ ID NO: 2 is provided below:

MCPGALWVALPLLSLLAGSLQGKPLQSWGRGSAGGNAHSPLGVPGGGLPEHTF NLKMFLENVKVDFLRSLNLSGVPSQDKTRVEPPQYMIDLYNRYTSDKSTTPASNIVRSFS MEDAISITATEDFPFQKHILLFNISIPRHEQITRAELRLYVSCQNHVDPSHDLKGSVVIYDV LDGTDAWDSATETKTFLVSQDIQDEGWETLEVSSAVKRWVRSDSTKSKNKLEVTVESH RKGCDTLDISVPPGSRNLPFFVVFSNDHSSGTKETRLELREMISHEQESVLKKLSKDGSTE AGESSHEEDTDGHVAAGSTLARRKRSAGAGSHCQKTSLRVNFEDIGWDSWIIAPKEYEA YECKGGCFFPLADDVTPTKHAIVQTLVHLKFPTKVGKACCVPTKLSPISVLYKDDAGVP TLKYHYEGMSVAECGCR (SEQ ID NO: 2).

In some embodiments, the BMP9 polypeptide comprises a sequence having at least 80% identity with SEQ ID NO: 2. In some embodiments, the BMP9 polypeptide comprises a sequence having at least 80%, at least 85%, at least 90%, at least 91%, at least 92%, at least 93%, at least 94%, at least 95%, at least 96%, at least 97%, at least 98%, at least 99%, or 100% identity with SEQ ID NO: 2.

In some embodiments, the BMP9 polypeptide comprises a portion of SEQ ID NO: 1 or a portion of SEQ ID NO: 2. For example, in some embodiments the BMP9 polypeptide is a synthetic peptide comprising amino acids 320-429 (e.g. the growth factor domain) of SEQ ID NO: 1 or SEQ ID NO: 2. For example, in some embodiments the BMP9 polypeptide comprises SAGAGSHCQKTSLRVNFEDIGWDSWIIAPKEYEAYECKGGCFFPLADDVTPTKHAIVQT LVHLKFPTKVGKACCVPTKLSPISVLYKDDMGVPTLKYHYEGMSVAECGCR (SEQ ID NO: 3). In some embodiments, the BMP9 polypeptide comprises a sequence having at least 80% identity (e.g. at least 80%, at least 85%, at least 90%, at least 91%, at least 92%, at least 93%, at least 94%, at least 95%, at least 96%, at least 97%, at least 98%, at least 99%, or 100% identity) with SEQ ID NO: 3. In some embodiments, the BMP9 polypeptide comprises SAGAGSHCQKTSLRVNFEDIGWDSWIIAPKEYEAYECKGGCFFPLADDVTPTKHAIVQT LVHLKFPTKVGKACCVPTKLSPISVLYKDDAGVPTLKYHYEGMSVAECGCR (SEQ ID NO: 4). In some embodiments, the BMP9 polypeptide comprises a sequence having at least 80% identity (e.g. at least 80%, at least 85%, at least 90%, at least 91%, at least 92%, at least 93%, at least 94%, at least 95%, at least 96%, at least 97%, at least 98%, at least 99%, or 100% identity) with SEQ ID NO: 4.

In some embodiments, the at least one BMP signaling activator comprises a BMP9 polypeptide, and/or an I-SMAD inhibitor (e.g. SMAD6 inhibitor, SMAD7 inhibitor) and/or a SMURF inhibitor. For example, in some embodiments the at least one agent comprises a BMP9 polypeptide (which promotes/activates/increases BMP9 activity by promoting BMP9-mediated phosphorylation of SMAD1/5/9), and additionally an I-SMAD inhibitor and/or a SMURF inhibitor is used to prolong this BMP9 signaling (e.g. by inhibition of an inhibitor of BMP9 signaling). In some embodiments, the at least one BMP9 signaling activator comprises a BMP9 polypeptide and a SMURF inhibitor. In some embodiments, the at least one BMP signaling activator comprises a BMP9 activator and an I-SMAD inhibitor (e.g. SMAD6 inhibitor, SMAD7 inhibitor). In some embodiments, the at least one BMP signaling activator comprises a SMURF inhibitor. The SMURF inhibitor may inhibit SMURF1 and/or SMURF2.

In some embodiments, the SMURF inhibitor a small molecule SMURF inhibitor. In some embodiments, the SMURF inhibitor selectively inhibits SMURF1 (e.g. inhibits SMURF1 and does not inhibit other SMURF proteins, e.g. SMURF2. In some embodiments, the SMURF inhibitor inhibits SMURF1 and SMURF2. In some embodiments, the SMURF inhibitor selectively inhibits SMURF2 (e.g. inhibits SMURF2 but does not inhibit other SMURF proteins, e.g. SMURF1.

In some embodiments, the SMURF inhibitor is A01 or a derivative thereof. A01 ([4-[[4-Chloro-3-(trifluoromethyl)phenyl]sulfonyl]-1-piperazinyl][4-(5-methyl-1H-pyrazol-1-yl)phenyl]methanone) has the following structure:

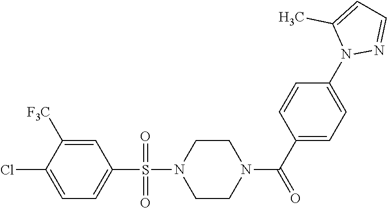 [SMILES: Cc1ccnn1-c1ccc(C(=O)N2CCN(S(=O)(=O)c3ccc(Cl)c(C(F)(F)F)c3)CC2)cc1]

In some embodiments, the SMURF inhibitor is Smurf1-IN-1 or a derivative thereof, shown below:

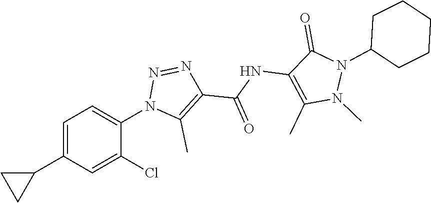 [SMILES: Cc1c(C(=O)Nc2c(C)n(C)n(C3CCCCC3)c2=O)nnn1-c1ccc(C2CC2)cc1Cl]

In some embodiments, the SMURF inhibitor is B06 or a derivative thereof. B06 is shown below:

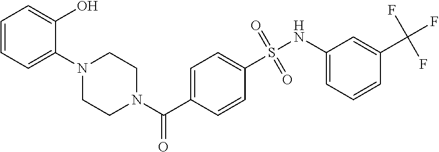 [SMILES: O=C(c1ccc(S(=O)(=O)Nc2cccc(C(F)(F)F)c2)cc1)N1CCN(c2ccccc2O)CC1]

In some embodiments, the SMURF inhibitor is B75 or a derivative thereof. B75 is shown below:

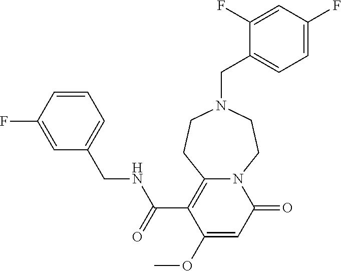 [SMILES: COc1cc(=O)n2c(c1C(=O)NCc1cccc(F)c1)CCN(Cc1ccc(F)cc1F)CC2]

In some embodiments, the composition comprises an osmotic agent. In some embodiments, the osmotic agent is an oncotic agent or a small molecule osmotic agent, such as a saccharide or an anion. In some embodiments, the composition comprises a plurality of osmotic agents, including a plurality of different types of osmotic agents (e.g. a colloid and a small molecule). In some embodiments, the osmotic agent is lactobionate, raffinose, mannitol, sucrose, glucose, and/or histidine. In some embodiments, the osmotic agent is an oncotic agent. In some embodiments, the oncotic agent comprises a high molecular weight colloid. A high molecular weight colloid refers to a colloid with molecules larger than 20 kDa. In some embodiments, the high molecular weight colloid is larger than 30 kDa. In some embodiments, the oncotic agent comprises dextran (e.g. Dextran 40), albumin (e.g. human serum albumin), gelatin, hydroxyethyl starch, and/or polyethylene glycol. In some embodiments, the organ preservation solution further comprises one or more sugars, electrolytes, antioxidants, free radical scavengers, buffering agents, amino acids, vasodilators, antibiotics, anti-inflammatory agents, and/or chelators. Exemplary sugars include glucose, sucrose, lactose, mannitol, and raffinose. In some embodiments, the electrolytes comprise potassium, sodium, magnesium, calcium, chloride, sulfate, phosphate, bicarbonate, and/or citrate. Exemplary antioxidants/free radical scavengers include allopurinol and glutathione. In some embodiments, the buffering agent comprises a phosphate buffer. In some embodiments, the composition comprises tryptophan, adenosine, adenine, glutamic acid, histidine, or ketoglutarate. Exemplary vasodilators include, for example, prostaglandin, nitroglycerin, verapamil, nitric oxide, adenosine, and/or rho-kinase inhibitors. In some embodiments, the anti-inflammatory agent is dexamethasone. In some embodiments, the chelator is an iron chelator, e.g. deferoxamine, HBED, deferiprone, deferasirox, etc.

In some embodiments, the organ preservation composition is perfused into the organ. In some embodiments, the methods herein involve perfusing the organ with the at least one agent (e.g. the BMP9 polypeptide, the SMAD6 inhibitor, and/or the SMURF inhibitor) and one or more additional reagents that promote lung health (e.g. buffers, salts/electrolytes, proteins, polysaccharides, inhibitors, etc.). For example, STEEN™ solution is commonly used for EVLP of lung transplants. The at least one agent (e.g. BMP9 polypeptide, I-SMAD inhibitor, and/or SMURF inhibitor) may be added to a perfusion solution (e.g. STEEN™) and perfused through the lung to improve organ viability.

In some embodiments, the organ is contacted with the organ preservation composition ex-vivo. The term “ex-vivo” indicates that the organ exists outside of a living body, for example outside of the body of the donor and outside of the body of the recipient of the organ. The organ may be contacted with the organ preservation composition at any suitable point in time. In some embodiments, the organ is contacted with the organ preservation composition prior to cold-storage of the organ. “Cold-storage” refers to storage of the organ at temperature of between 2 and 15 °C. In some embodiments, cold-storage occurs at about 4 °C. In some embodiments, the organ is contacted with the organ preservation composition during cold-storage of the organ. In some embodiments, the organ is contacted with organ preservation solution prior to and during cold-storage of the organ, which can protect the organ against subsequent ischemia reperfusion injury during/after transplantation.

In some embodiments, the organ is contacted with the organ preservation composition prior to or during reperfusion of the organ. The term “reperfusion” refers to recovery of oxygen flow to the organ after a period of oxygen deprivation. For example, oxygen deprivation to the organ may occur during the process of extracting the organ from the donor and storing the organ. Reperfusion occurs when the organ is transplanted into a subject and blood flow resumes, restoring oxygen delivery to the organ. Commonly, this process of ischemia (e.g. oxygen deprivation) and reperfusion (e.g. oxygen recovery) can result in a phenomena referred to as “ischemia and reperfusion injury” or “IRI”. In some embodiments, the compositions and methods herein protect the organ from ischemia and reperfusion injury and thus increase transplant viability. For example, in some embodiments the organ is contacted with the organ preservation composition prior to or during transplantation of the organ into a recipient (e.g. prior or during to reperfusion).

Ex-vivo perfusion procedures can be performed on organs prior to transplant to improve organ viability, and the compositions herein may be applied before, during, and/or after ex-vivo perfusion. For example, for lung transplants procedures referred to as ex-vivo lung perfusion, or EVLP, are used. EVLP involves circulating a perfusate containing nutrients and oxygen through the lungs ex-vivo while they are ventilated. In some embodiments, the organ (e.g. lung) is contacted with the organ preservation composition during an ex-vivo lung perfusion procedure. For example, a BMP9 polypeptide may be added to the perfusate and circulated through the lung during EVLP, prior to transplant.

Contacting the organ with the organ preservation solution (e.g. a composition comprising a BMP9 polypeptide, whether alone or in combination with an I-SMAD inhibitor and/or a SMURF inhibitor), including before cold-storage, during perfusion, or before/during reperfusion, can improve multiple outcomes of organ health/viability. For example, contacting the organ (e.g. lung) with BMP9 is shown herein to reduce endothelial cell loss or damage, reduce pulmonary edema, reduce glucose uptake, reduce lactate production, and/or increase probability of survival of the organ after transplant. As such, the methods of improving organ viability herein may improve viability by achieving any one or more of these or other desirable organ outcomes, thus improving organ health during storage and/or improving health and viability after transplantation into the subject.

In some embodiments, contacting the organ with the at least one BMP9 signaling activator comprises contacting the organ with at least one dose of the agent (e.g. the BMP9 signaling activator, which may be present in an organ preservation solution herein). In some embodiments, the organ receives multiple doses of the agent/composition. For example, in some embodiments the method comprises contacting the organ with at least two doses (e.g. 2, 3, 4, 5, 6, 7, 8, 9, or 10 or more doses) of the agent/composition in a given time window. The dosing frequency and spacing between doses may vary depending on the conditions of the organ during dosing with the at least one agent/composition. For example, organs may be given multiple doses of the agent/composition during the time course that the organ is in cold-storage, which can vary depending on the intended recipient and readiness for transplant. As another example, the organ may be given multiple doses of the agent/composition during an ex-vivo lung perfusion procedure. The doses may be spaced evenly over the time window or may be given at variable intervals, for example at a relatively increased dosing frequency initially with tapered dosing over time. In some embodiments, the organ is continuously exposed to the composition for a suitable duration of time, e.g. a window of time prior to cold-storage, a window of time during cold-storge or the entirety of the cold-storage period, a window of time prior to transplant, a window of time during transplant, etc.

In some embodiments, the dose of the agent delivered to the organ is about 100 ng of the agent (e.g. BMP9 signaling activator) per kg of weight of the organ (e.g. 100 ng/kg) to about 1 mg/kg. In some embodiments, the dose of the agent delivered to the organ is about 100 ng/kg to about 1 mg/kg, about 250 ng/kg to about 500 μg/kg, about 500 ng/kg to about 100 μg/kg, about 750 ng/kg to about 50 μg/kg, or about 1 μg/kg to about 25 μg/kg. In some embodiments, the dose of the agent delivered to the organ is about 100 ng/kg to about 100 μg/kg, about 200 ng/kg to about 50 μg/kg, about 300 ng/kg to about 25 μg/kg, about 400 ng/kg to about 15 μg/kg, about 500 ng/kg to about 10 μg/kg, about 600 ng/kg to about 7.5 μg/kg, about 700 ng/kg to about 5 μg/kg, about 800 ng/kg to about 2.5 μg/kg, about 900 ng/kg to about 2 μg/kg, or about 1 μg/kg to about 2 μg/kg. In some embodiments, the dose of the agent delivered to the organ is about 100 ng/kg to about 5 μg/kg. In some embodiments, the dose of the agent delivered to the organ is about 100 ng/kg to about 5 μg/kg, about 250 ng/kg to about 4.5 μg/kg, about 500 ng/kg to about 4 μg/kg, about 750 ng/kg to about 3 μg/kg, or about 1 μg/kg to about 2 μg/kg.

### EXPERIMENTAL

### Example 1

### Activation of BMP9 Signaling Improves Lung Transplant Viability

408A Mutant Human proBMP9

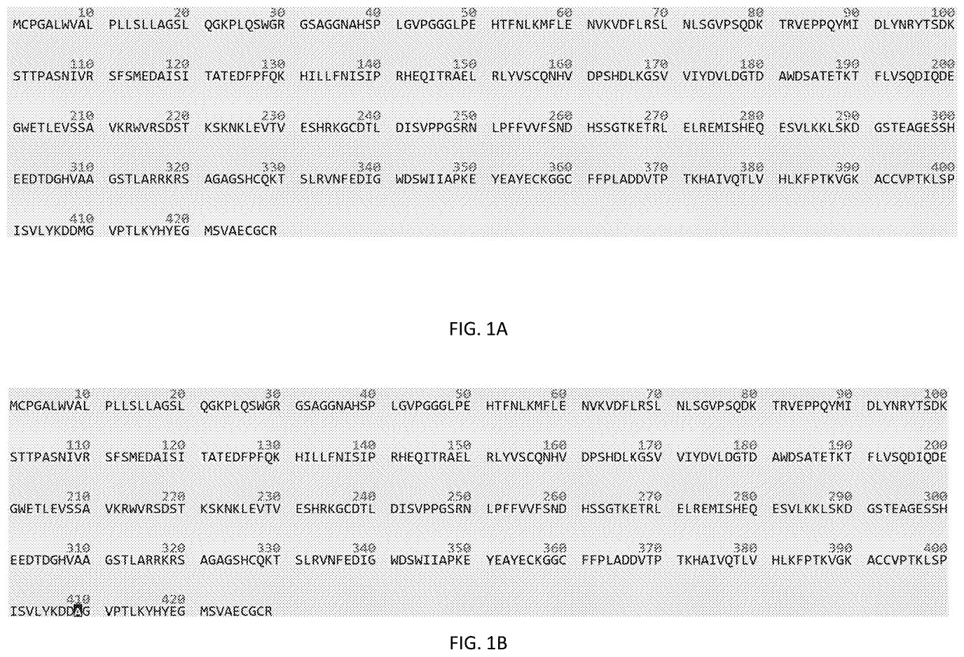

WT human gdf2 encodes the protein bone morphogenetic protein 9 (BMP9), which contains 429 amino acids (FIG. 1A, SEQ ID NO: 1). BMP9 is synthesized as a preproform and processed into the mature ligand and the prodomain during secretion. The total length of 429 amino acids is considered the preproform of the protein. Amino acids 1-22 comprise of the signal peptide that traffics the protein to the golgi. Amino acids 23-319 makeup the pro-domain of the protein. Amino acids 320-429 form the growth factor domain. In the golgi, Furin cleaves the covalent bond between the pro-domain and the growth factor domain (GFD, amino acids 320-429). The pro-domain and GFD then form a non-covalent association, forming proBMP9 (pBMP9). proBMP9 monomers dimerize before secretion. Once secreted, circulating BMP9 binds a heterotetramer of high affinity type-I and type-II receptors. WT BMP9 is a potent mediator of osteogenesis as well as vascular endothelial homeostasis by inducing intracellular receptor-small mothers against decapentaplegic (R-SMADs). R-SMADs are regulated by inhibitory-SMADS (I-SMADs) and once phosphorylated, interact with the common-SMAD (Co-SMAD), SMAD4, to translocate to the nucleus and induce target gene expression. Inhibitor of DNA binding 1, a helix-loop-helix transcription factor that lacks its own DNA-binding domain, is the most well-described target gene of vascular BMP9 signaling.

The 408A mutant of BMP9 (FIG. 1B, SEQ ID NO: 2) has been shown to have no osteogenic signaling capabilities as revealed by its inability to induce alkaline phosphatase activity in C2C12 cells while retaining its endothelial signaling capabilities. The 408A mutant BMP9 has been investigated under the name “MGX292” for use in pulmonary arterial hypertension (PAH). The 408A mutant was reported to have less osteogenic activity compared to WT in vivo as well (Morrell et al., Am J Respir Crit Care Med. 207:A6729.)

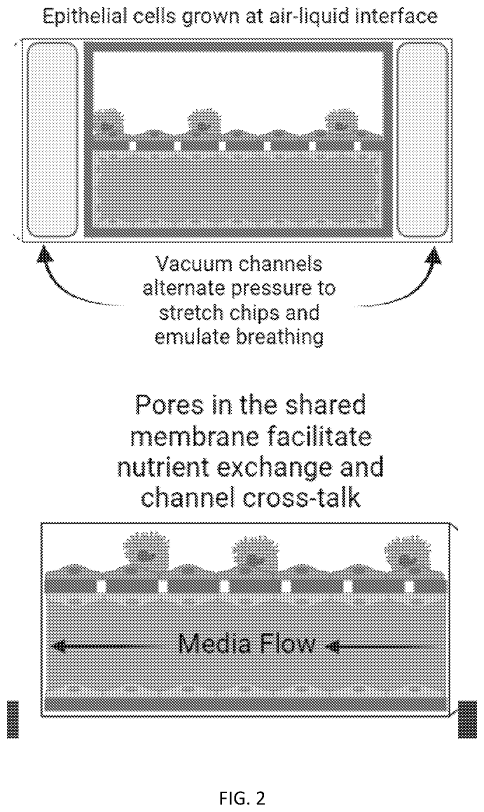

Herein, it was investigated whether BMP9 can improve lung health, e.g. prior to transplantation. A lung-on-a-chip model was developed and used to recapitulate features of lungs after ex-vivo lung perfusion. The lung-on-a-chip model (FIG. 2) recapitulates the mechanical stress of breathing and perfusion, type 1 and 2 alveolar epithelial differentiation, and polarization and transcription. Epithelial cells were grown to confluency at 37 degrees C at the membrane interface of culture media (liquid) and air in a chip. The chip contains channels through which reagents can be perfused to come into contact with the membrane and the epithelial cells grown thereupon. During standard perfusion, vacuum channels on either end of the chip alternate pressure to stretch the chips and emulate the mechanical force of breathing while pores in the membrane (e.g. the membrane interface) facilitate nutrient exchange and channel cross-talk.

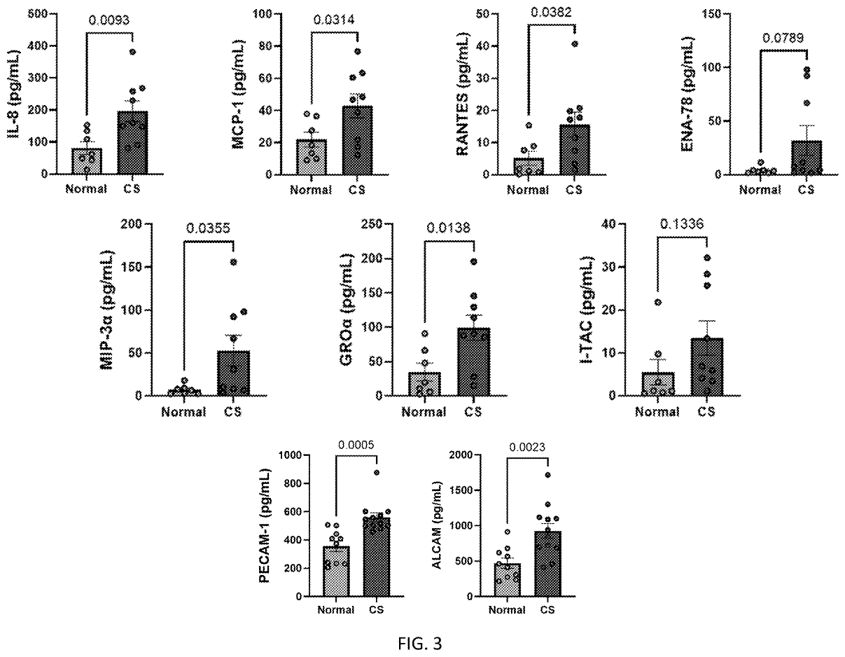

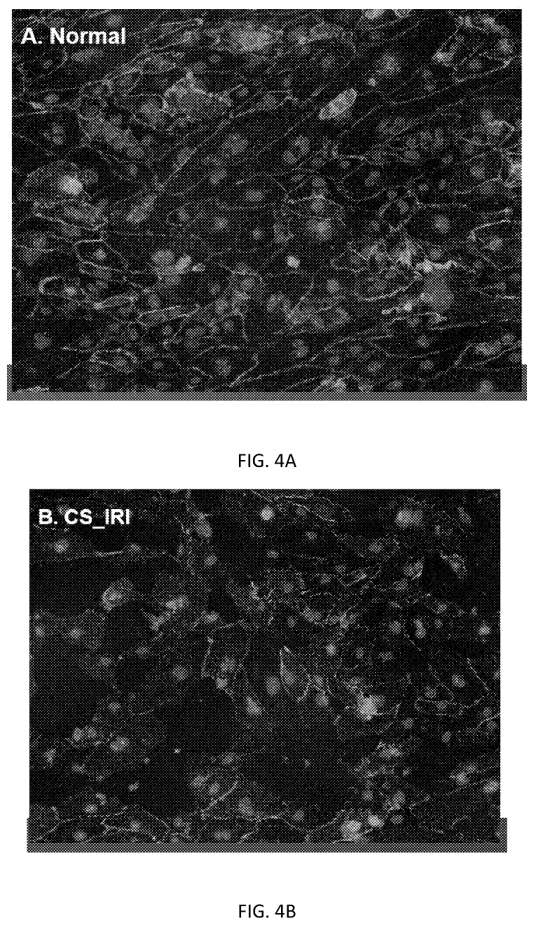

In the cold-storage ischemia reperfusion injury model, after 48 hours of standard perfusion described above, preservation solution (Perfadex®) was perfused through the endothelial channel and the chip was placed at 4 degrees C for 6 hours in a hyperoxygen chamber (100% oxygen). After 6 hours, reperfusion solution was perfused through the chip and standard perfusion parameters were re-initiated (i.e. reperfusion was performed) for 24 hours. Perfusate was collected and downstream analyses were conducted to evaluate for markers of epithelial injury (IL-8, MCP-1, RANTES, ENA-78, MIP-3α, GROα, I-TAC, PECAM-1, and ALCAM). Results are presented in FIG. 3. As shown in FIG. 3, levels of all markers of epithelial injury were increased following cold-storage ischemic reperfusion injury (CS-IRI) compared to levels in the standard perfusion condition. Results were statistically significant for IL-8, MCP-1, RANTES, MIP-3α, PECAM-1, and ALCAM. Epithelial injury was evaluated visually by microscopy of the membrane using DAPI to visualize nuclei (blue) and VE-Cad to visualize endothelial cells (red), visually demonstrating significantly less epithelial cells in standard perfusion conditions compared to post CS-IRI (FIG. 4A, FIG. 4B).

Gene expression in the endothelial cells following standard perfusion and CS-IRI was also evaluated. Nanostring nCounter Human Organ Transplant Gene Expression was analyzed in Sartorius Simca by PCA-X. Results demonstrate that CS-IRI alters the gene expression profile from that seen in normal no injured chip epithelial and endothelial cells. These gene alterations were associated with injury and inflammation pathways that are activated by CS-IRI.

Taken together, these results demonstrate that the lung-on-a-chip model of cold-storage ischemia reperfusion injury provides a clinically relevant model to evaluate agents that improve outcomes in lung grafts. Agents that can improve outcomes for lung grafts, specifically agents that improve outcomes after cold-storage ischemia reperfusion injury, were next investigated.

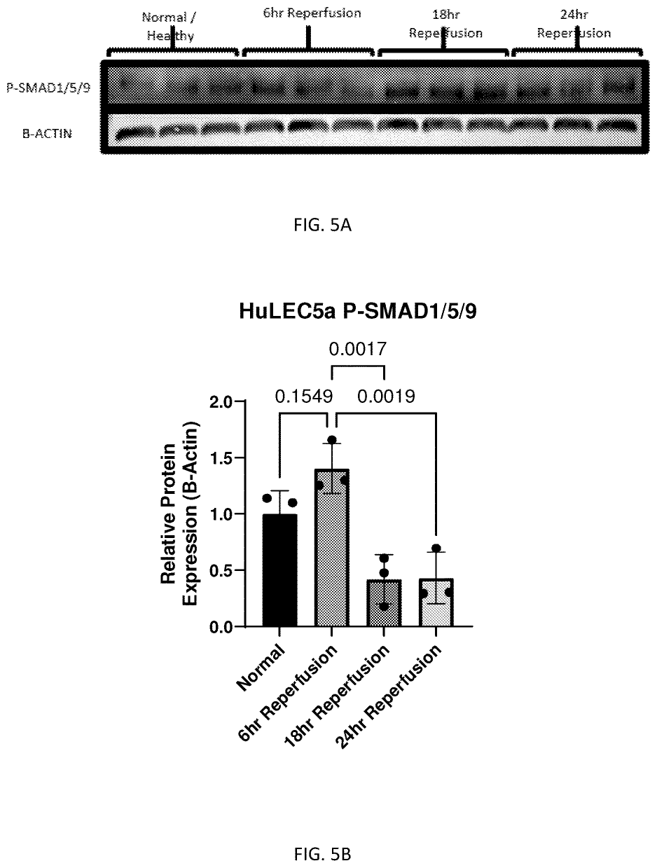

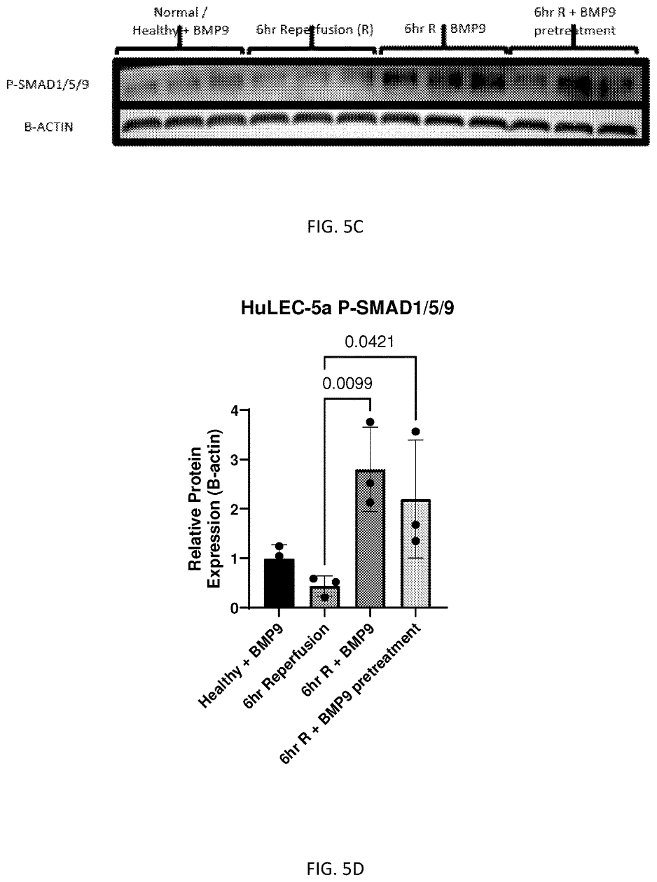

HuLEC-5a cells were used in a static culture model. Reperfusion was conducted for 6 hours, 18 hours, or 24 hours. Reperfusions in the presence and absence of exogenous BMP9 were evaluated. Results are shown in FIG. 5. As shown in FIG. 5A and FIG. 5B, SMAD signaling declines after 6 hours of reperfusion, as evidenced by decreased levels of phosphorylated SMAD1/5/9. As in FIG. 5C and FIG. 5D, addition of BMP9 at the time of reperfusion (e.g. the presence of BMP9 in the reperfusion media) or pre-treatment with BMP9 prior to cold-storage significantly increase pSMAD1/5/9 levels. These results demonstrate that the presence of BMP9, whether added prior to reperfusion or at the time of reperfusion, protects endothelial cells.

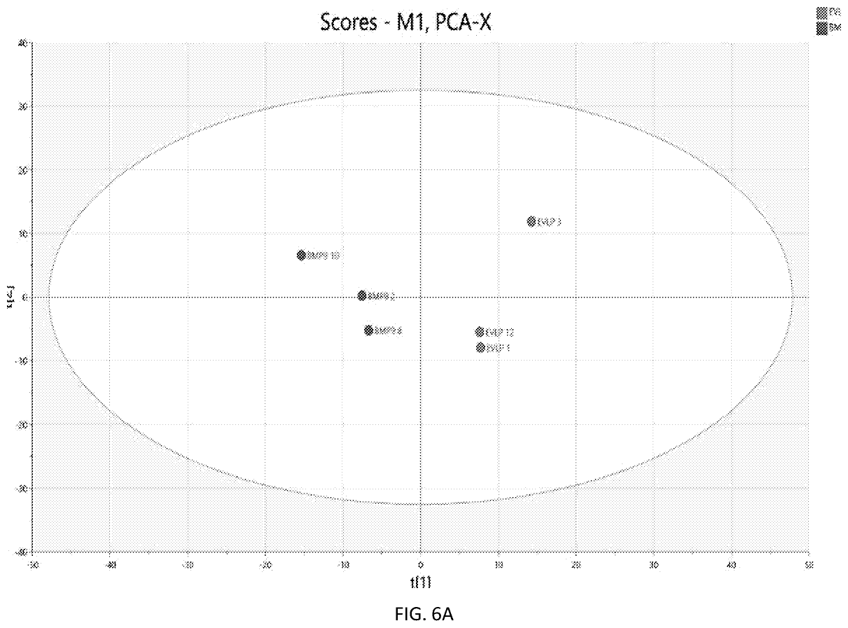

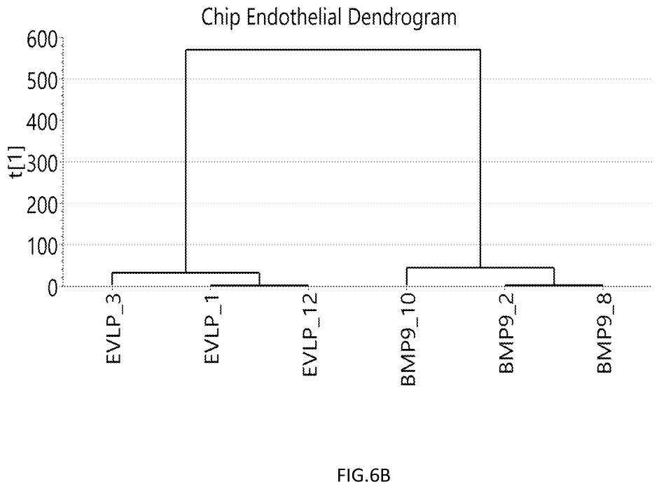

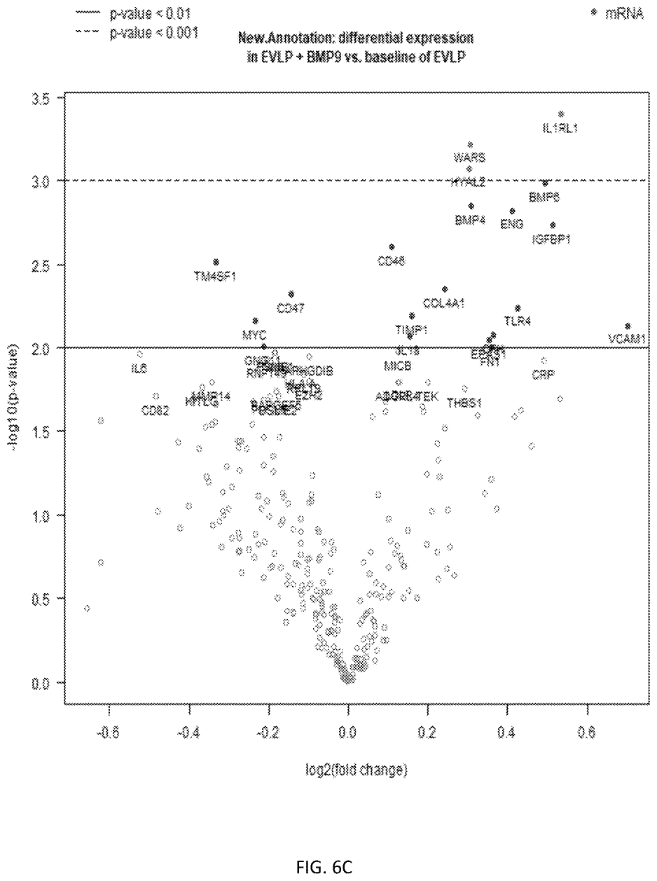

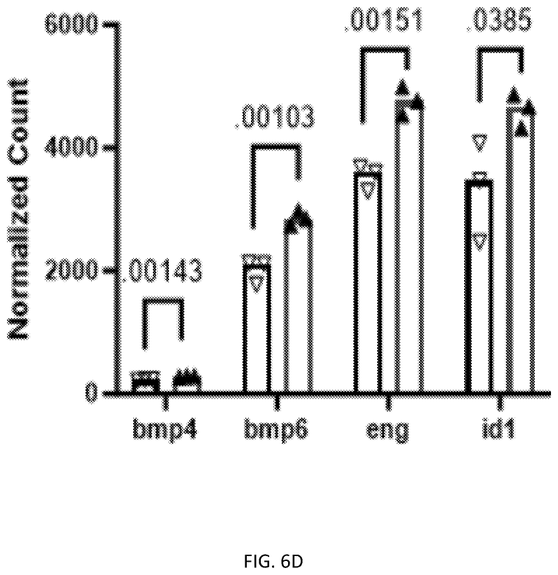

To further evaluate the impact of BMP9, a principal component analysis (PCA-X) model was generated of lung on a chip modeled ex-vivo lung perfusion (EVLP) and EVLP+BMP9 treated emulate alveolar lung-on-a-chips using SIMCA. The PCA-X was constructed from a Nanostring nCounter human organ transplant gene expression dataset from the mRNA collected from the vascular endothelial compartment of the lung chip. SIMCA was then used to generate a dendrogram using Ward's criteria for hierarchal clustering. The volcano plot was generated from nSolver v4.0. As shown in FIG. 6, BMP9 treatment increased the expression of vascular endothelial bmp4, bmp6, endoglin, and id1 following CS-EVLP-IRI. N=3.

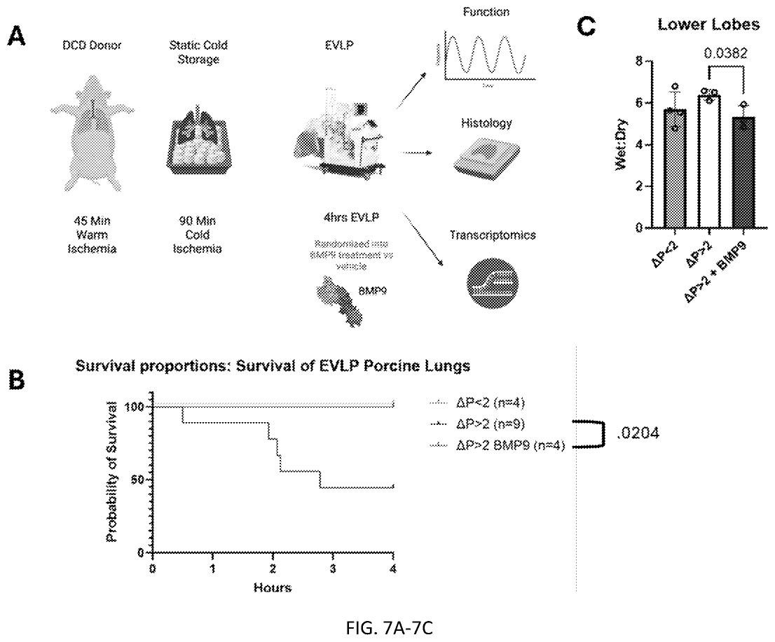

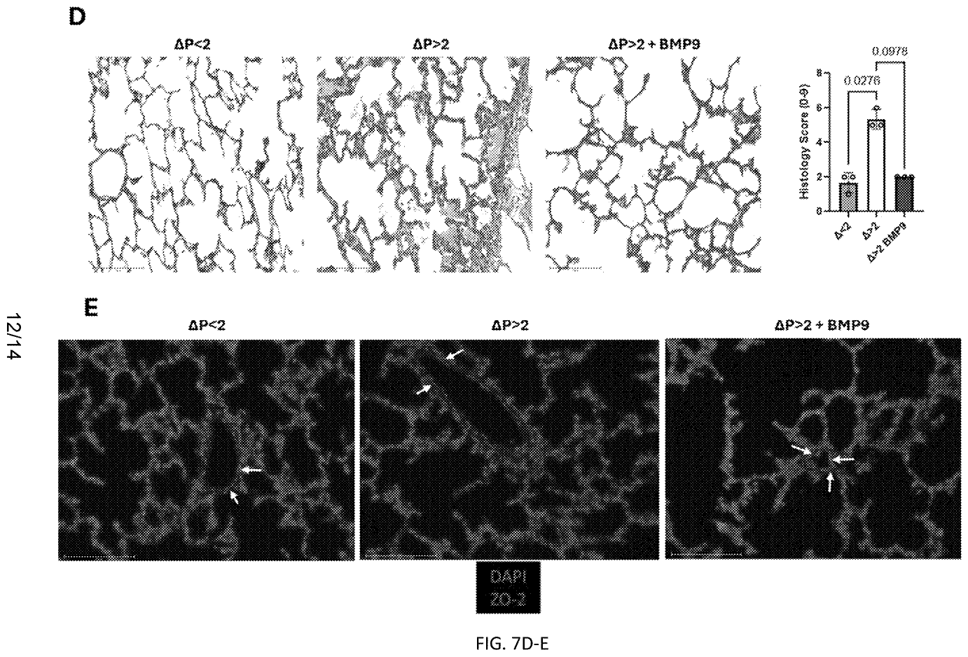

The impact of BMP9 treatment was further investigated using porcine lungs harvested and placed on EVLP for 4 hours using STEEN solution. A schematic of the experimental design is shown in FIG. 7A. Donor pigs underwent 45 minutes of warm ischemia followed by 90 minutes of static cold storage. Lungs were then placed on ex vivo lung perfusion (EVLP) for 4 hours, during which treatments (vehicle or BMP9) were administered. Functional assessment, histologic analysis, and transcriptomic profiling were performed at the end of EVLP. Results are presented in FIG. 7B-E. Changes in the vascular resistance, e.g. changes in the difference between arterial and pulmonary pressures (ΔP) were monitored, wet:dry ratio was measured, survival of lungs was evaluated, and histological assessments were performed. Kaplan-Meier survival analysis of lungs during EVLP is shown in FIG. 7B. Control lungs (ΔP>2 cmH₂O; n=4) exhibited early functional decline, whereas BMP9-treated lungs (ΔP>2+BMP9; n=4) maintained stability throughout the perfusion period. Lungs with ΔP<2 cmH₂O (n=9) served as a low-injury reference group. Lung wet-to-dry weight ratio of lower lobes following EVLP is shown in FIG. 7C. BMP9 treatment significantly reduced pulmonary edema compared to untreated injured lungs (ΔP>2), indicating improved barrier function (*p=0.0382). FIG. 7D shows representative hematoxylin and eosin (H&E)-stained sections of lung tissue following EVLP across experimental groups: low-injury (ΔP<2), injured (ΔP>2), and BMP9-treated injured lungs (ΔP>2+BMP9). Injured lungs (ΔP>2) demonstrate increased alveolar septal thickening, inflammatory infiltration, and structural disruption compared to ΔP<2 controls, while BMP9 treatment preserves alveolar architecture and reduces histologic injury. Quantification of lung injury score demonstrates a reduction with BMP9 treatment compared to ΔP>2 lungs (p values as indicated). FIG. 7E shows representative immunofluorescence images of lung tissue stained with DAPI (blue) and ZO-2 (red), a tight junction protein, following EVLP. Injured lungs (ΔP>2) exhibit disrupted and discontinuous ZO-2 staining (arrows), indicative of impaired endothelial/epithelial barrier integrity, whereas BMP9-treated lungs show preservation of junctional localization similar to ΔP<2 controls.

Biochemical properties of porcine lungs after treatment are shown in Table 1. Data were analyzed by ANOVA with post-hoc Tukey Test.

TABLE 1
Biochemical properties of Porcine Lungs on Ex Vivo Lung Perfusion at 1 hour
and 4 hours measured by iStat.

| | | | | | p-value | p-value |
|---|---|---|---|---|---|---|
| | | | | p-value | ΔP > 2 vs | ΔP < 2 vs |
| | | | | ΔP < 2 vs | ΔP > 2 + | ΔP > 2 + |
| Analyte | ΔP < 2 | ΔP > 2 | ΔP > 2 + BMP9 | ΔP > 2 | BMP9 | BMP9 |
| 1 hour | | | | | | |
| Na+ | 148.6 ± .8 | 138.17 ± 2.19 | 142.75 ± 7.08 | 0.0054 | 0.2783 | 0.1596 |
| K+ | 3.78 ± .15 | 4.07 ± .16 | 3.95 ± .05 | 0.0143 | 0.424 | 0.2458 |
| iCa | .816 ± .02 | .759 ± .02 | 755 ± .02 | 0.4741 | 0.9841 | 0.4702 |
| Glucose | 145.6 ± 6.62 | 123.4 ± 11.89 | 137.75 ± 17.27 | 0.0384 | 0.2491 | 0.6732 |
| Lactate | 2.24 ± .19 | 2.52 ± .53 | 2.193 ± .62 | 0.6375 | 0.5952 | 0.9918 |
| pH | 7.19 ± .13 | 7.14 ± .02 | 7.19 ± .06 | 0.657 | 0.6146 | 0.9978 |
| 4 hour | | | | | | |
| Na+ | 154 ± .63 | 146.67 ± 3.0 | 151 ± 3.67 | 0.0265 | 0.2214 | 0.3694 |
| K+ | 4.36 ± .10 | 5.13 ± .82 | 4.5 ± .24 | 0.1458 | 0.2788 | 0.9112 |
| iCa | .816 ± .02 | .807 ± .01 | .835 ± .04 | 0.9205 | 0.5204 | 0.6753 |
| Glucose | 128.8 ± 14.51 | 85.667 ± 5.56 | 129 ± 18.99 | 0.0186 | 0.0312 | 0.9999 |
| Lactate | 5.256 ± .73 | 7.18 ± .33 | 4.54 ± 1.51 | 0.1121 | 0.0372 | 0.6403 |
| pH | 7.16 ± .07 | 7.05 ± .02 | 7.03 ± .21 | 0.6483 | 0.9763 | 0.48 |

Lungs that received exogenous recombinant human WT BMP9 had multiple improved properties compared to controls. For example, glucose uptake is a marker for acute lung rejection. As shown in Table 1, glucose uptake was significantly higher in lungs that underwent EVLP with for 1 hour and for 4 hours that had an initial ΔP>2 (as evidenced by decreased glucose levels in collected perfusate) compared to lungs that underwent EVLP and had an initial ΔP<2. Glucose levels were restored by treatment with BMP9 (e.g. BMP9 treatment suppressed this increase in glucose uptake). As another example, increased lactate production reflects increased lung injury. Lactate levels were significantly higher in the ΔP>2 group as compared (ΔP<2 group. Lactate levels were reduced by treatment with BMP9 as compared to ΔP>2.

Taken together, the results herein demonstrate that treatment with BMP9, either before cold-storage or before reperfusion, results in significantly improved outcomes in the lung. The results demonstrate efficacy of treatment with BMP9 in an in-vitro EVLP lung-on-a-chip model and in ex-vivo porcine EVLP model.

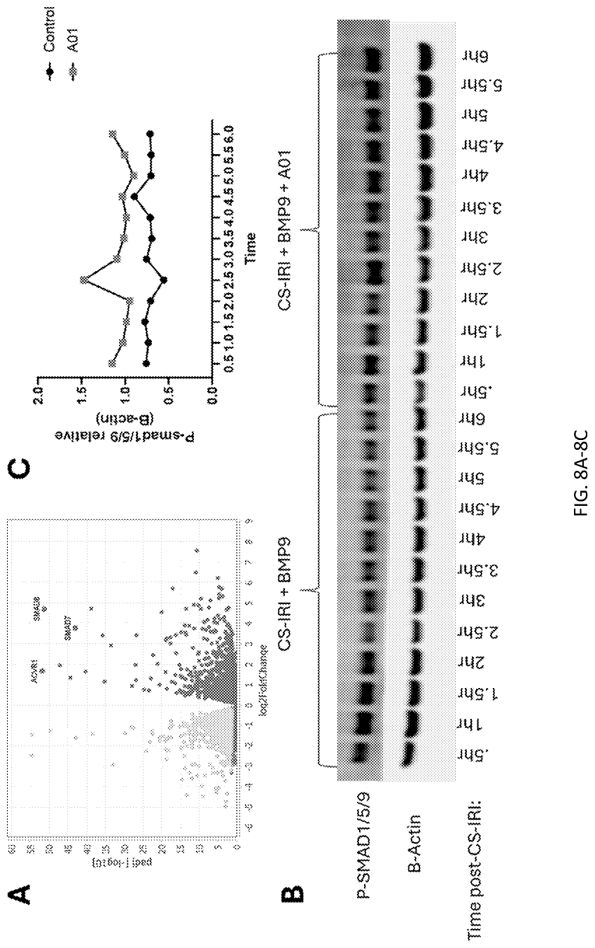

To evaluate whether prolonged enhancement of BMP9 signaling would further improve outcomes, the small molecule SMURF1 inhibitor A01 was tested in addition to BMP9. FIG. 8A shows a volcano plot generated from Qiagen's Ingenuity Pathway Analysis. Leftmost genes (green) are upregulated by CS and rightmost genes (red) are upregulated by BMP9 following CS-IRI. Note that inhibitory (I)-Smads 6 & 7, which provide feedback inhibition to canonical BMP signaling, are two of the most differentially regulated genes between CS and BMP9 treatment conditions. FIG. 8B shows western Blot depicting that with concomitant treatment of BMP9 and A01, a small molecule SMURF1 inhibitor, microvascular endothelial intracellular P-SMAD1/5/9 expression was increased post-CS-IRI. SMURF1 is an E3 ubiquitin ligase that targets Receptor (R)-Smads through interaction with I-SMADs. FIG. 8C shows the area under the curve (AUC) was plotted to examine the effect of SMURF1 inhibition on signaling. The AUC value for controls was 7.969 and the AUC value for A01 treatment was 11.66. Together, these data highlight that inhibition of negative regulators of BMP9 signaling, which are low in CS treated microvascular endothelial cells, have therapeutic potential to modulate BMP9 signaling and may be used alone or in combination with BMP9 to promote organ health and viability.

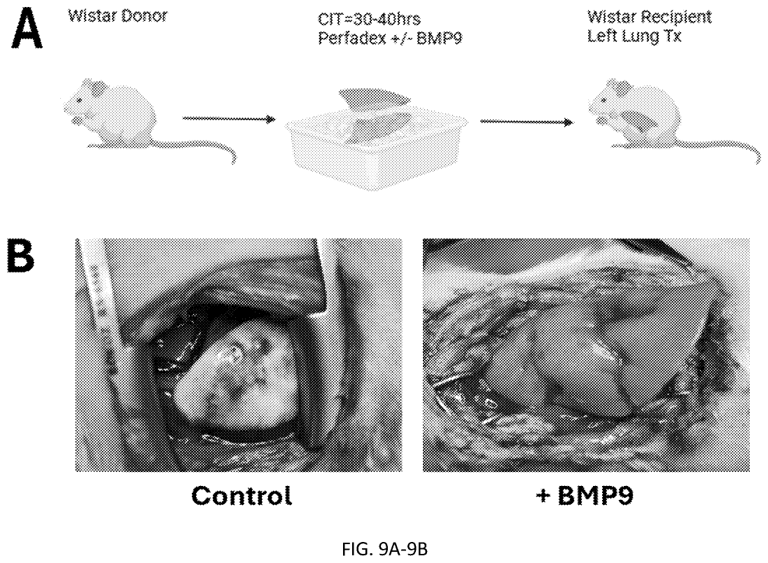

Further experiments were conducted to evaluate the effect of BMP9 supplementation during cold storage in a rodent lung transplant model. An experimental schematic of the prolonged cold storage lung transplant model is shown in FIG. 9A. Donor Wistar rat lungs were harvested and stored for 40 hours in Perfadex® preservation solution supplemented with recombinant BMP9 prior to orthotopic left lung transplantation into Wistar recipients. Transplanted lungs were assessed at 5 days post-transplant. Representative gross images of transplanted lungs at 5 days post-transplantation are shown in FIG. 9B. Lungs preserved with BMP9 during extended cold storage demonstrate preserved graft viability and perfusion, with maintained tissue integrity compared to expected deterioration following prolonged ischemic storage. These findings illustrate the ability of BMP9 supplementation to extend permissible cold ischemic time and support successful graft function following transplantation.

What is claimed is:

1. An organ preservation composition comprising an osmotic agent and at least one BMP9 signaling activator.

2. The organ preservation composition of claim 1, wherein the osmotic agent comprises lactobionate, raffinose, mannitol, sucrose, glucose, histidine, and/or an oncotic agent.

3. The organ preservation composition of claim 1, wherein the osmotic agent comprises an oncotic agent selected from dextran, albumin, gelatin, hydroxyethyl starch, and/or polyethylene glycol.

4. The organ preservation composition of claim 1, further comprising one or more sugars, electrolytes, antioxidants, free radical scavengers, buffering agents, amino acids, vasodilators, antibiotics, anti-inflammatory agents, and/or chelators.

5. The organ preservation composition of claim 1, wherein the at least one BMP9 signaling activator comprises:
a) a BMP9 polypeptide; and/or
b) a SMAD6 and/or SMAD7 inhibitor, and/or
c) a SMURF inhibitor.

6. The organ preservation composition of claim 5, wherein the at least one BMP9 polypeptide comprises an amino acid sequence having at least 90% sequence identity to SEQ ID NO: 3 or SEQ ID NO: 4.

7. The organ preservation composition of claim 5, wherein the at least one BMP9 polypeptide comprises SEQ ID NO: 3 or SEQ ID NO: 4.

8. The organ preservation composition of claim 5, wherein the at least one BMP9 polypeptide comprises an amino acid sequence having at least 80% identity to SEQ ID NO: 1 or SEQ ID NO: 2.

9. The organ preservation composition of claim 5, wherein the at least one BMP9 polypeptide comprises an amino acid sequence having at least 90% identity with SEQ ID NO: 1 or SEQ ID NO: 2.

10. The organ preservation composition of claim 5, wherein the at least one BMP9 polypeptide comprises an amino acid sequence having at least 95% identity with SEQ ID NO: 1 or SEQ ID NO: 2.

11. The organ preservation composition of claim 5, wherein the at least one BMP9 polypeptide comprises SEQ ID NO: 1 or SEQ ID NO: 2.

12. The organ preservation composition of claim 5, wherein the SMURF inhibitor is A01.

13. The organ preservation composition of claim 5, wherein the at least one BMP9 signaling activator comprises a BMP9 polypeptide and a SMURF inhibitor.

14. A method of improving organ viability, comprising contacting the organ with the organ preservation composition of claim 1.

15. The method of claim 14, wherein the organ is a candidate graft organ for transplant into a recipient.

16. The method of claim 14, wherein the organ is a lung, liver, or kidney.

17. The method of claim 14, wherein said contacting comprises perfusing the organ with the organ preservation composition.

18. The method of claim 14, comprising contacting the organ with the organ preservation composition ex-vivo.

19. The method of claim 14, comprising contacting the organ with the organ preservation composition:
(a) prior to and/or during cold-storage of the organ,
(b) prior to and/or during reperfusion of the organ, and/or
(c) prior to and/or during transplantation of the organ into a recipient.

20. The method of claim 14, wherein contacting the organ with the organ preservation composition reduces endothelial cell loss or damage, reduces pulmonary edema, reduces glucose uptake, reduces lactate production, and/or increases probability of survival of the organ during storage and/or after transplantation into the recipient.
